(19) United States
(12) Patent Application Publication
(10) Pub. No.: US 2015/0169972 A1
(43) Pub. Date: Jun. 18, 2015

(54) CHARACTER DATA GENERATION BASED ON TRANSFORMED IMAGED DATA TO IDENTIFY NUTRITION-RELATED DATA OR OTHER TYPES OF DATA

(71) Applicants: Nhat Vu, Palo Alto, CA (US); Stuart Crawford, Piedmont, CA (US); Janeth Moran-Cervantes, Ventura, CA (US)

(72) Inventors: Nhat Vu, Palo Alto, CA (US); Stuart Crawford, Piedmont, CA (US); Janeth Moran-Cervantes, Ventura, CA (US)

(73) Assignee: AliphCom, San Francisco, CA (US)

(21) Appl. No.: 14/105,146

(22) Filed: Dec. 12, 2013

(51) Int. Cl. G06K 9/18; G06K 9/62

(52) U.S. Cl. CPC G06K 9/18; G06K 9/6267

(57) ABSTRACT

Embodiments relate generally to wearable/mobile computing devices and computer software configured to perform image processing, including transformation of images of characters into data representing characters. More specifically, disclosed are wearable systems, platforms and methods directed to, for example, health and wellness, for identifying character data, such as text, from captured image data, including but not limited to the identification of nutrition-related information captured as an image. In various embodiments, a method can include receiving an image that includes characters, and identifying a sub-image of a group of characters. Adaptations of the sub-image can be generated to form an adapted sub-image. The method includes transforming data that can be classified by subsets of character data. A converted group of characters can be formed based on at least the classified subsets. The method can also include coupling a plurality of the converted group of characters.

### FIELD

Embodiments relate generally to wearable electrical and electronic hardware, computer software, wired and wireless network communications, and to wearable/mobile computing devices configured to perform image processing, including transformation of images of characters into data representing characters. More specifically, disclosed are wearable systems, platforms and methods directed to, for example, health and wellness, for identifying character data, such as text, from captured image data, including but not limited to the identification of nutrition-related information captured as an image.

### BACKGROUND

Conventional image processing techniques have been adapted for use with mobile devices, such as mobile phones having a camera, a processor and a display, to capture images of bar codes for identifying associated information associated with an item, such as a consumable (e.g., food or drink). A user of a mobile device that desires to obtain nutrition information typically invokes an application to match a bar code to data stored in a repository for retrieving relevant information, such as an amount of calories, protein, sodium, etc., for a specific serving of a consumable. Drawbacks to the above-identified techniques typically include a requirement to access a database that is incomplete or omits certain nutritional information for specific barcode. In such cases, a user may manually enter the information, should such nutritional information being available (e.g., there are cases in which a barcode may exist on a package of a product without nutrition label). Incomplete databases and relatively large instances of manual data entry tend to undermine the users' experiences.

Another approach to capturing written information, such as nutritional information found on packages of food or drink, uses optical character recognition (“OCR”) technologies that have been adapted for use with mobile devices or a remote server (e.g., a remote web server). FIG. 1 is a diagram 100 showing a conventional system for capturing image text and performing OCR conversions in an attempt to obtain data representing nutritional information for use in an application or storage in a database. Computing device 110 is configured to provide image data 106 based on, for example, a picture of a nutritional label. Remote server 102 retrieves image data 106 via networks 104, and performs a conventional OCR conversion for transmission as nutrition data 107. As shown, conventional OCR conversion usually gives rise, at least in some cases, to errors as shown on display 112 of computing device 110. Alternatively, a mobile device 120 containing an application for performing a conventional OCR conversion to obtain nutritional data, may generate information, in at least some cases, with errors as shown on display 122 of mobile device 120. Conventional OCR conversion engines are generally adapted for usage with two-dimensional scanned documents. While functional, the above-described approaches usually require user intervention typically more than is desired by users that seek to obtain nutrition data.

Thus, what is needed is a solution for obtaining data that represent characters from captured images without the limitations of conventional techniques.

### BRIEF DESCRIPTION OF THE DRAWINGS

Various embodiments or examples (“examples”) of the invention are disclosed in the following detailed description and the accompanying drawings:

FIG. 1 is a diagram 100 showing a conventional system for capturing image text and performing OCR conversions in an attempt to obtain data representing nutritional information for use in an application or storage in a database;

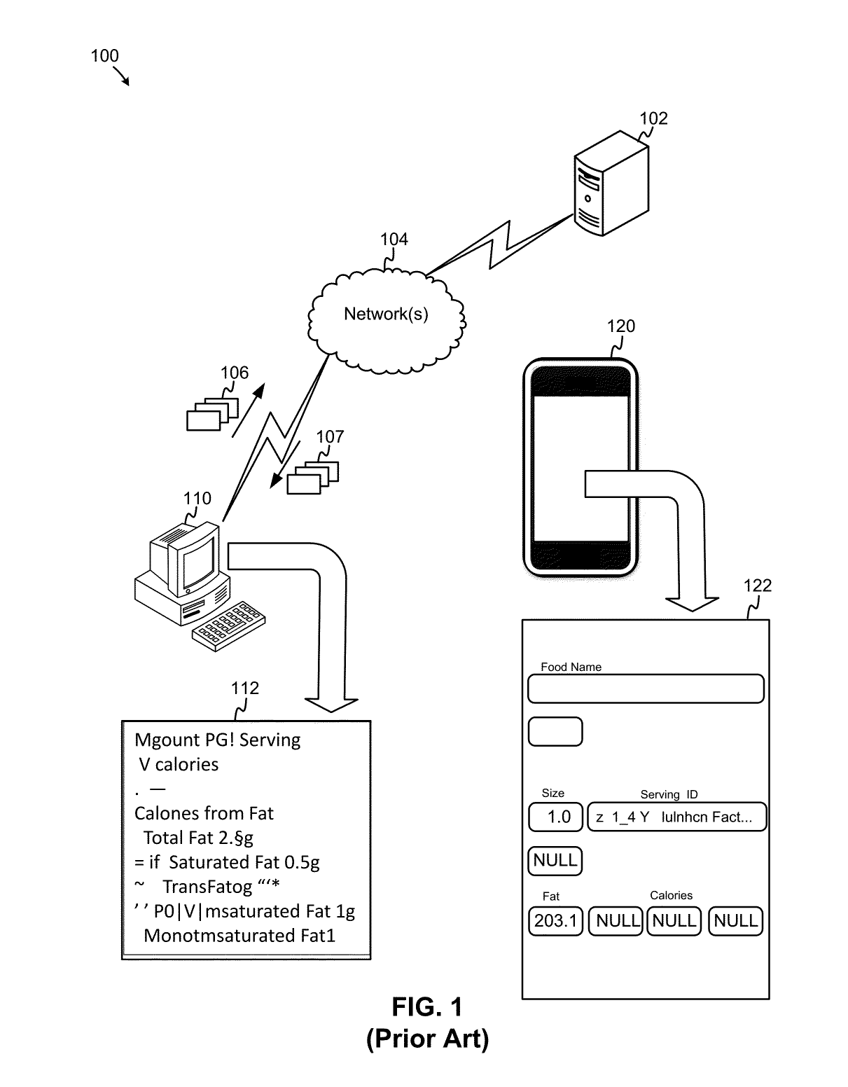

FIG. 2 illustrates an example of an information extractor, according to some embodiments;

FIG. 3 depicts an example of a nutrition information extractor, according to some embodiments;

FIG. 4 depicts an example of a sub-image detector, according to some embodiments;

FIG. 5 is a diagram including an adapted sub-image generator, according to some embodiments;

FIG. 6 is an example of a character data classifier, according to some embodiments;

FIG. 7 is a diagram including an example of a converted character grouping optimizer, according to some embodiments;

FIG. 8 is a diagram of an example of a converted character grouping aggregator, according to some embodiments;

FIG. 9 is a diagram depicting a parser, according to some embodiments;

FIG. 10 is a diagram depicting an image enhancer, according to some embodiments;

FIG. 11 is a diagram depicting various computing devices in which an information extractor (or a portion thereof) can be disposed, according to various embodiments; and

FIG. 12 illustrates an exemplary computing platform disposed in a media device, mobile device, or any computing device, for implementing a nutrition label information extractor, according to various embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

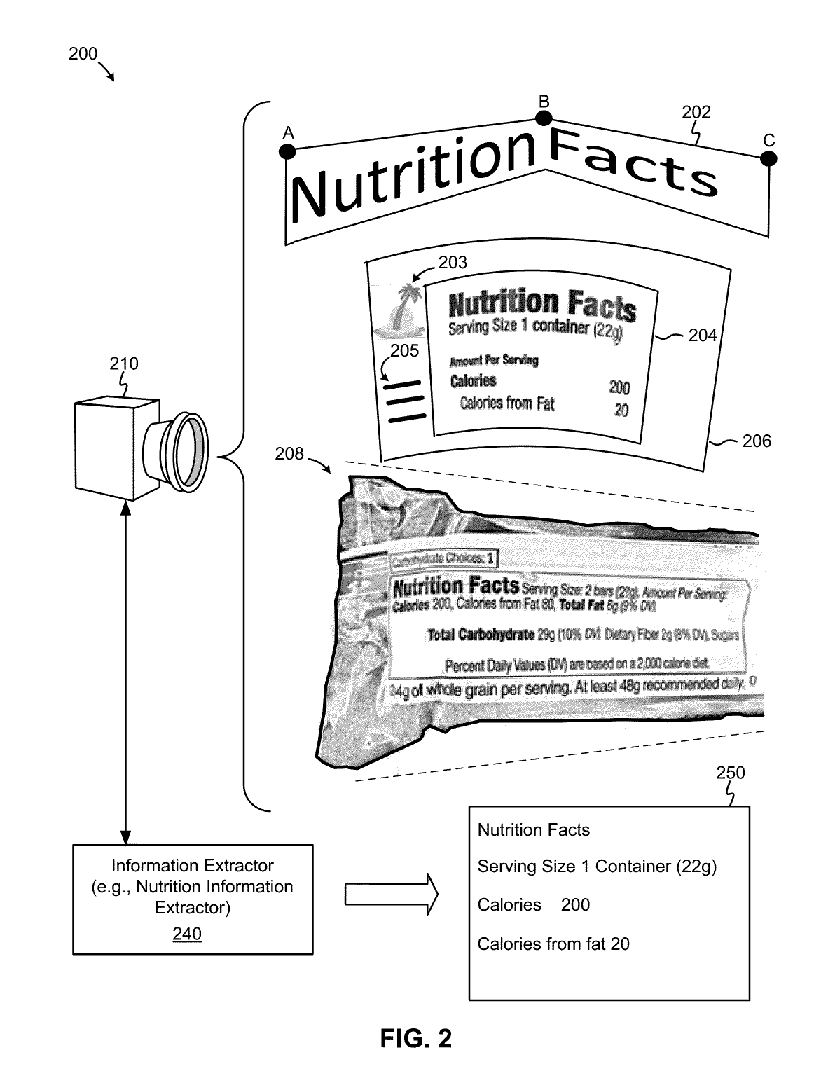

FIG. 2 illustrates an example of an information extractor, according to some embodiments. Diagram 200 depicts an information extractor 240 coupled to an image capture device 210, which is configured to capture one or more images that include symbols, such as characters, text, written information, or the like. In this example, information extractor 240 can be configured as a nutrition information extractor that is configured to identify characters and groups of characters associated with, for example, a pool of national-related information, and further configured to provide data representing characters that constitute nutritional information, as shown in display 250 or data file 250. Diagram 200 further depicts examples of symbols disposed on various surfaces from which image data can be captured and extracted by information extractor 204, according to various embodiments. A surface can be a two- or three-dimensional shape of a enclosure, such as a package, that is configured to contain a consumable (e.g., food or drink). Variability in one or more surfaces characteristics can influence image data generated by image capture device 210. Examples of surface characteristics include physical features, such as the orientation of the surface, surface shape (e.g., a can of coconut water may have a cylindrical surface), surface topology (e.g., local variations in surface orientations due to wrinkles, bends, folds, creases, etc. in a package material), surface texture, shading, shadows on the surface, reflective nature of a package material, and the like. Variability in one or more character characteristics can also influence image data generation. In some cases, variability in a character characteristic may be due to the influence of a surface characteristic (e.g., depth of field distances can cause blurriness and perceived text size reductions in characters that were further from a camera lens than characters that are near). However, variability in a character characteristic may be influenced by the manner in which the character was affixed to the surface. Examples of character characteristics include font type, text size, spacing, linear arrangements of text, color, and the like. Information extractor 240 is configured to resolve issues related to variability in surface characteristics, character characteristics, image characteristics due to camera-related parameters, and the like.

Consider a sampling of some examples of surfaces from which symbols, including characters, can be captured via image capture device 210. First consider that a captured image (e.g., a digitized image, video, photograph, or the like) of surface 202 indicates that point B on surface 202 is farther in the field of view than points A and C on surface 202. In particular, portions of surface 202 are oriented such that a first surface portion extending from point A to point B slants away from image capture device 210, and a second surface portion extending from point C point B also slants away. In some cases, the text may increase in blurriness due to depth of field-related effects from the first “N” near point A (e.g., least blurry) in the word “Nutrition” to the second “n” near point B (e.g., most blurry). According to some examples, information extractor 240 can adapt to variability in surface 202 and the text thereon. Next, consider surface 206 upon which surface portion 204 includes nutrition-related information. Note that surface portion 204 is curved coextensively with the curvature of surface 206. Adjacent the nutrition-related information can lie a graphic image 203 and other graphics 205. According to some examples, information extractor 240 can adapt to variability in surface 206 and the text thereon, as well as reducing or negating the influence of graphic image 203 and other graphics 205 in detecting characters. Surface 208 is associated with a package that has variability in surface characteristics, such as wrinkles, reflective portions, an angled orientation, etc., as well as variability in the size of the text, format of text (e.g., bold text), etc. Information extractor 240 can also compensate for these variability to more accurately extract character data from an image captured by image capture device 210 of surface 208.

In view of the foregoing, information extractor 240 can facilitate enhanced and/or reliable character data extraction based on characters detected in images. For example, information extractor 240 can localize the extraction of character data associated with sub-images to exclude or substantially exclude graphics that otherwise might improperly influence character identification, and to compensate for variability in surface, in text, and the like. As another example, information extractor 240 need not be limited to conventional OCR processing that may be limited to extracting text from flat surfaces (e.g., a scanned document). As such, information extractor 240 can compensate for the curvature in the surface of packaging as well as other physical variations in the surface. Further, information extractor 240 can enhance the accuracy of transforming images of characters into character data by, for example, evaluating transformed character data against the context in which the image is captured. For instance, information extractor 240 can have a specialized dictionary or repository of nutrition-related data against which character data can be compared to improve character, word, and phrase formation, as well as testing character data (e.g., numbers, quantities, percentages of daily values (“DV”) of nutrients, etc.) within the context to optimize accuracy of the determination of characters, including alpha-numeric characters, and words.

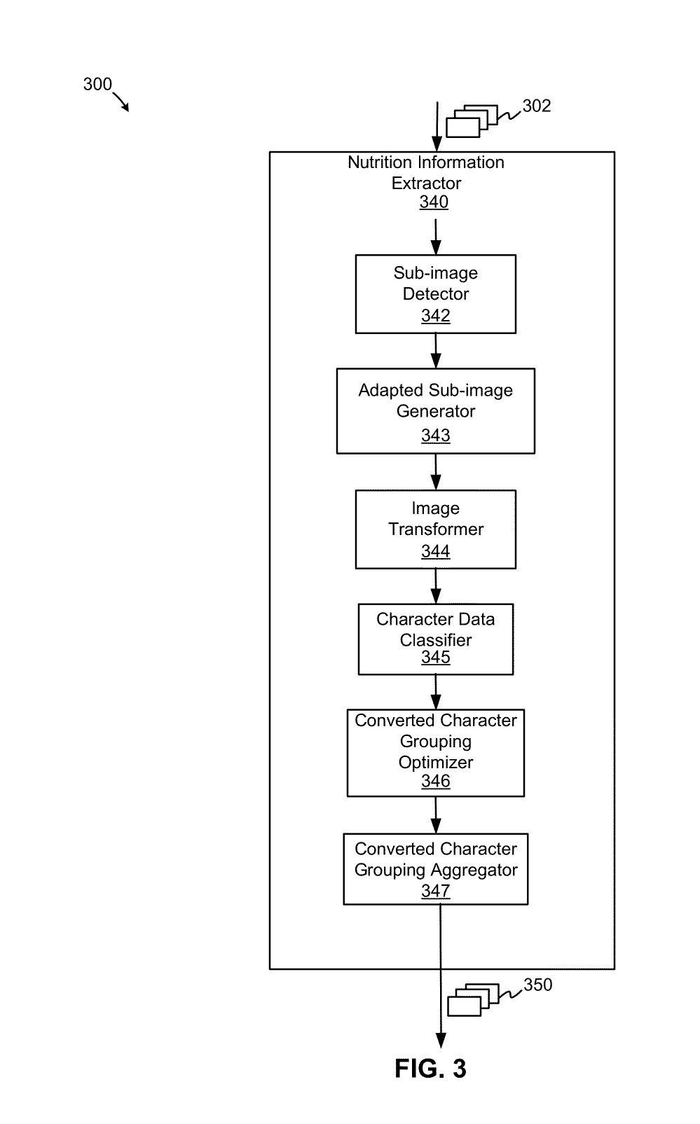

FIG. 3 depicts an example of a nutrition information extractor, according to some embodiments. Diagram 300 shows that nutrition information extractor 340 is configured to receive image data 302 of text, and is further configured to generate character data 350 that includes data representing characters, text, numbers, and the like that are extracted from image data 302. In some cases, image data 302 can represent an image of an enclosure as an object, the enclosure including a nutrition label associated with contents of the enclosure (e.g., contents may be food, drink, or other consumable). The characters or symbols in the nutrition label can constitute nutrition-related information. Nutrition information extractor 340 also is shown to include a sub-image detector 342, an adapted sub-image generator 343, an image transformer 344, a character data classifier 345, a converted character grouping optimizer 346, and a converted character grouping aggregator 347.

Sub-image detector 342 is configured to detect a localized portion of a surface that includes, or has a relatively likely probability of including, an image of one or more characters. Thus, sub-image detector 342 can identify data representing a sub-image of a group of characters (i.e., a group of one or more characters). In some cases, sub-image detector 342 can identify or otherwise form a boundary about a detected character. For example, the boundary can be represented as a boundary box. In some examples, sub-image detector 342 can use edge detection, ridge detection, and the like, or variants thereof to detect characters in an image. In some other examples, a technique associated with blob detection may be used to identify candidates for the one or more characters (e.g., likely characters), and sub-image detector 342 can compare the candidates against a database including known characters to confirm or correct a character, thereby enhancing character identification in a sub-image.

Adapted sub-image generator 343 is configured to generate adaptations of the sub-image to form data representing an adapted sub-image. For example, adapted sub-image generator 343 can be configured to receive sub-image data representing the group of characters identified by sub-image detector 342, and modify the sub-image as a function of a characteristic of image data representing the sub-image. Adapted sub-image generator 343 forms one or more adapted sub-images based on a different value for the characteristic of the image data. For example, a characteristic of image data can refer to a characteristic of a pixel, such as a color value, a brightness value, a luminance or luminosity value, and the like, or any value derived by using, for example, a mathematical transform or image processing algorithm. Other known characteristics of image data may also be used. According to some examples, the application of the sub-image of a group of characters (represented by image data) and/or the one or more adapted sub-images (represented by image data) to image transformer 344 can facilitate an enhancement in the accuracy of character detection and extraction for nutrition label information extractor 340.

Image transformer 344 is configured to transform a sub-image of a group of characters represented by image data and the one or more adapted sub-images (e.g., represented by adapted image data) into character data. Image transformer 344 operates to identify characters represented by image data and to transform the characters into data representing characters (e.g., character data, such as ASCII codes or other digital representation of characters). According to some embodiments, image transformer 344 generates a set of character data for each of the sub-image and one or more adapted sub-images. The sets of the character data are provided to another portion of nutrition label information extractor 340, which can analyze the difference in the sets of the characterized to identify variants introduced by the transformation process and resolve (e.g., correct) such variants. Thereafter, the other portion of nutrition label information extractor 340 can select an optimized version of the character data. In some examples, image transformer 344 is configured to perform optical character recognition to convert the image data into the character data. In a non-limiting example, image transformer 344 can include in OCR engine formed in association with hardware and/or an OCR algorithm implemented in association with executable instructions.

Character data classifier 345 is configured to select portions of the character data, which is data based on transformed image data for the sub-image of the group of characters and the one or more adapted sub-images. For example, a portion can represent a set (or a subset thereof) of the character data from a pool of including the sub-image of the group of characters and the one or more adapted sub-images. According to some examples, character data classifier 345 can be configured to characterize the portion of the character data as having at least one attribute for a particular context in which the character extraction process is performed. In a health and wellness context or in a nutrition-related context, the attribute can be associated with: data representing a word stored in memory or a database, data representing a number (e.g., to represent a quantity of units of a nutrient or nutrition-related information (e.g., 1 serving, or 200 calories), data representing a value of weight (e.g., to represent a weight of a nutrient, such as 1 mg Sodium), and data representing a value as a percentage daily value (“DV”), such 8% DV of Dietary Fiber, to form a characterized portion of the characterized data. In some cases, non-categorical characters can be assigned or replaced by a null character.

Converted character grouping optimizer 346 is configured to identify a collection of the classified subsets of the character data associated with a common attribute, analyze the collection of the classified subsets of the character data, and determine an optimal classified subset of the character data from a range of combinations of characters for the common attribute. A range of combination of characters can include a range of values of a character (e.g., a number representing weight or percentage), and can also include a range of character combinations or deviations from a dictionary word that indicate that a captured image-based character can be matched against a dictionary word (e.g., stored in memory or a database). In some cases, converted character grouping optimizer 346 can identify errant (or likely errant) characters, text, and numbers that can be converted (i.e., corrected) to an optimized or more accurate character, text, or number. For example, converted character grouping optimizer 346 can identify, based on a common attribute of percentage daily value (“DV”), the classified portions from each of the sets of character data for each of the sub-image of a group of characters and the one or more adapted sub-images. Thus, converted character grouping optimizer 346 can identify 8% DV, 8% DV, 8% DV, and 5% DV, and analyze whether 5% DV is an anomaly. Consider that converted character grouping optimizer 346 establishes an 8% DV as accurate character data, thereby determining an optimal classified subset of the character data. Converted character grouping optimizer 346 can also optimize other subsets for the character data. For example, converted character grouping optimizer 346 can identify, based on a common attribute of weight, the classified portions from each of the sets of character data to identify 29, 2 g, 12 g, and 2 g, and analyze whether 2 g is optimal. Should converted character grouping optimizer 346 determine 2 g is optimal, converted character grouping optimizer 346 can use both 2 g and 8% DV as accurate representations of portions of the character data.

Converted character grouping aggregator 347 is configured to identify a first converted group of characters and determine other converted groups of characters adjacent (e.g., in close proximity) to the first convert group. Converted character grouping aggregator 347 also can couple or otherwise connect the first converted group of characters to one of the adjacent converted groups of characters to form an arrangement of characters. For example, consider that converted character grouping aggregator 347 identifies a first converted group of characters having a word “Dietary” at an end of a linear arrangement, whereas an adjacent converted group of characters includes a word “Fiber” at the beginning of another linear arrangement. Based on context and/or data in a database, converted character grouping aggregator 347 can determine that the words “Dietary” and “Fiber” likely suggests or confirms that the first converted group ought to be connected with the adjacent converted group.

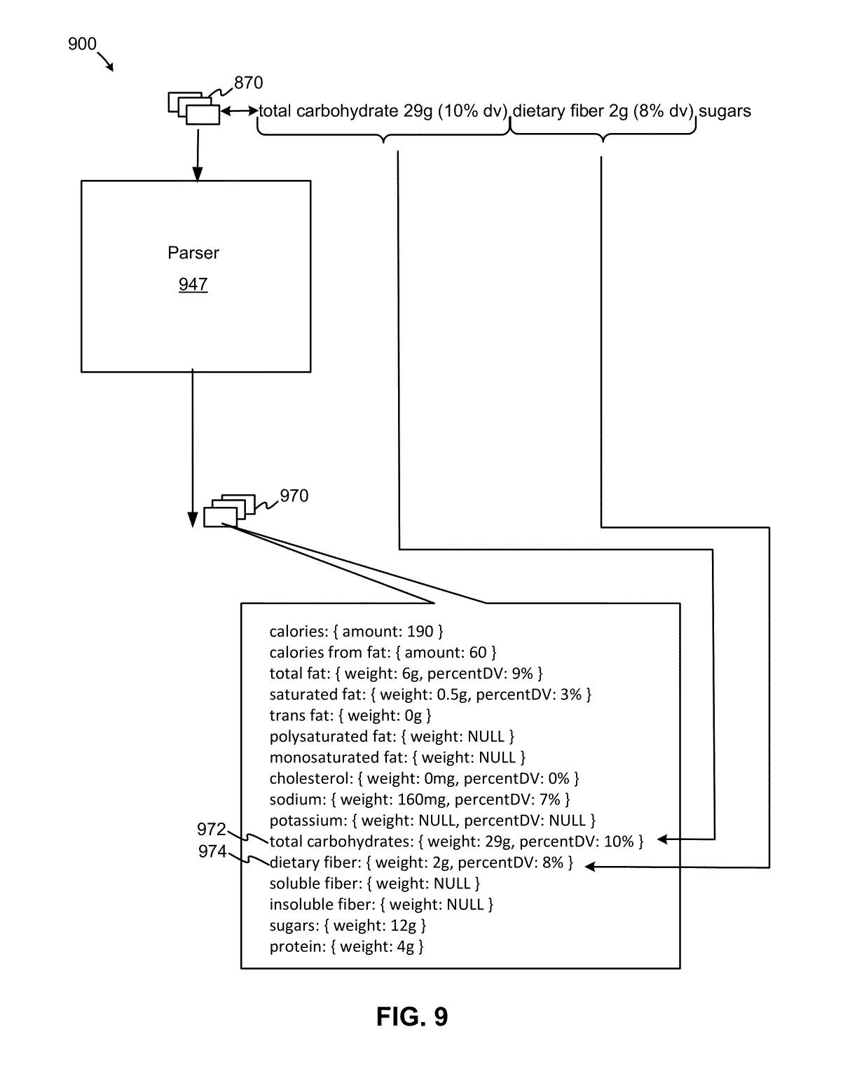

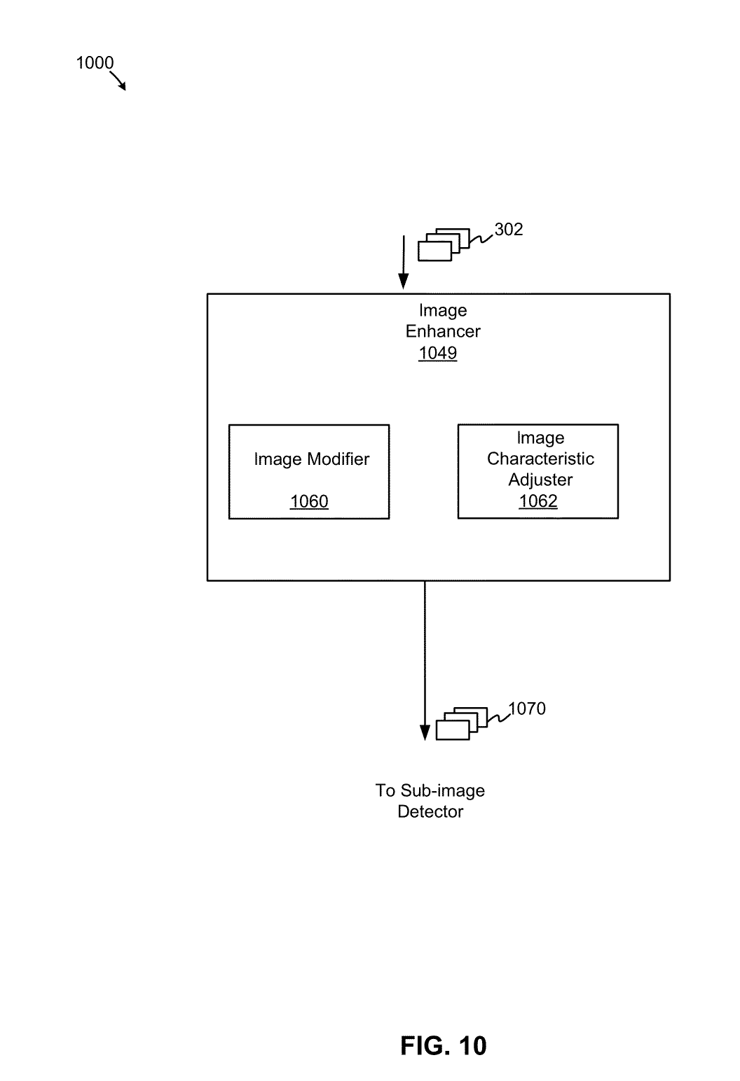

Note that more or fewer of the elements shown in nutrition information extractor 340 can be implemented in accordance with various embodiments. For example, a parser 947 of FIG. 9 may be implemented to receive data from converted character grouping aggregator 347, and an image enhancer 1049 of FIG. 10 can be implemented to provide enhanced image data to a sub-image detector.

In some embodiments, a computing device, such as a wearable computing device, a mobile device (e.g., a mobile phone) or any networked computing device (not shown) in communication with one or more of the above-mentioned devices, can provide at least some of the structures and/or functions of any of the features described herein. As depicted in FIG. 3 and subsequent figures (or preceding figures), the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in FIG. 3 (or any figure) can represent one or more algorithms. Or, at least one of the elements can represent a portion of logic including a portion of hardware configured to provide constituent structures and/or functionalities.

For example, a nutrition label information extractor 340 and/or any of its one or more components, such as sub-image detector 342, adapted sub-image generator 343, image transformer 344, character data classifier 345, converted character grouping optimizer 346, and converted character grouping aggregator 347 of FIG. 3 (or other figures) can be implemented in one or more computing such as desktop audio system (e.g., a Jambox® or a variant thereof), a mobile computing device, such as a wearable device or mobile phone (whether worn or carried), that include one or more processors configured to execute one or more algorithms in memory. Thus, at least some of the elements in FIG. 3 (or any other figure) can represent one or more algorithms. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, a nutrition label information extractor 340 and/or any of its one or more components, such as sub-image detector 342, adapted sub-image generator 343, image transformer 344, character data classifier 345, converted character grouping optimizer 346, and converted character grouping aggregator 347 of FIG. 3 (or other figures) can be implemented in one or more computing devices that include one or more circuits.

Thus, at least one of the elements in FIG. 3 (or any other figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Note that while the various examples provided herein relate to nutrition and health and wellness data, the various embodiments are not intended to be limited to nutrition and health and wellness. For example, the information extractor described herein can be implemented to extract information from any container regarding its contents, such as pharmaceutical containers configured to include a drug. Thus, an image can be captured of a prescription bottle from which the character data related to pharmaceuticals can be extracted. Also, and information extractor can extract information from a menu or any other document.

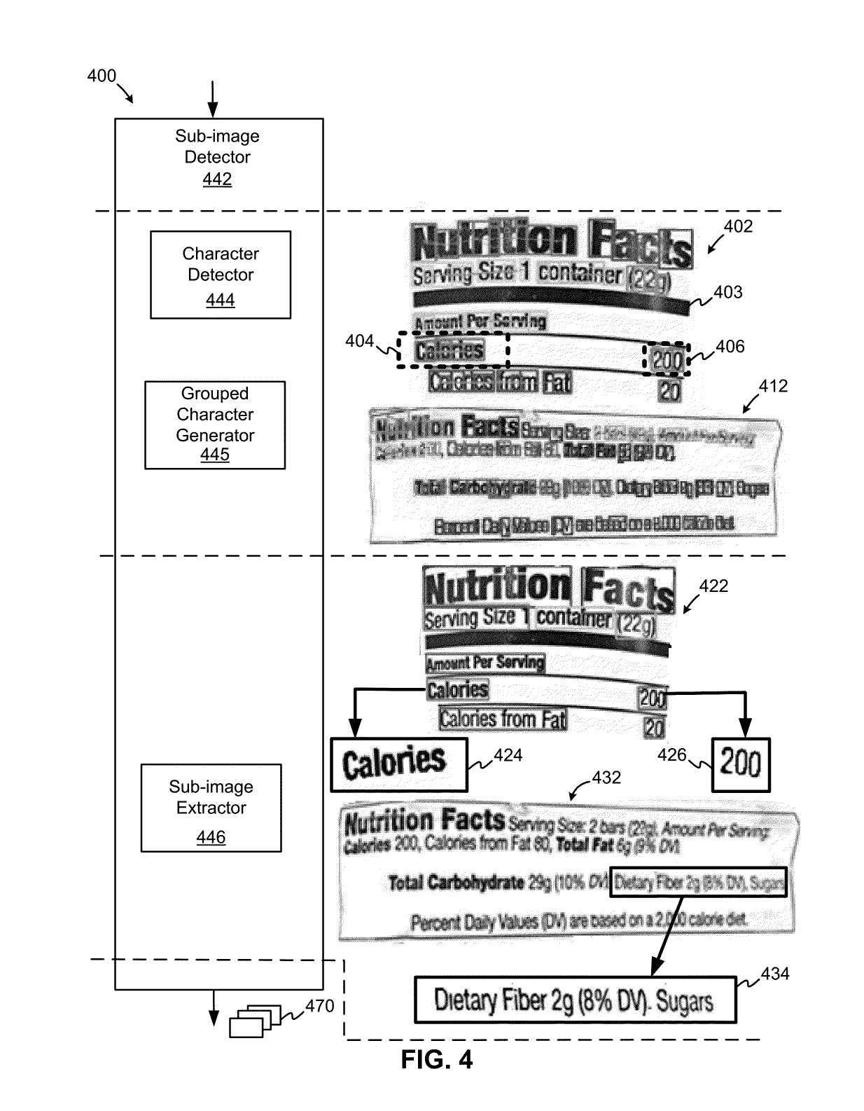

FIG. 4 depicts an example of a sub-image detector, according to some embodiments. Diagram 400 shows that sub-image detector 442 can include a character detector 444, a grouped character generator 445 and a sub-image extractor 446. Character detector 444 is configured to detect portions of the surface that include symbols or likely include symbols, such as characters (text, numbers, and the like). According to some embodiments, a symbol and/or character can include a glyph, or the two former terms can be used interchangeably with the latter. For a portion of the surface that includes a symbol, character detector 444 can identify a boundary or boundary box about a character. Diagram 400 includes a first captured image 402 and a second captured image 412, each of which shows characters or likely characters bounded by a square or rectangle. Graphics or non-characters such as graphic 403, are not identified as including characters, and thus character detector 444 does not associate a boundary with that graphic. In some examples, character detector 444 is configured to confirm whether a surface includes a character based on an aspect ratio (or the aspect ratio of its bounding box) relative to the size of the image or the image of the surface. For example, if an identified portion of a surface (e.g., a bounding box that includes a character) has an aspect ratio or any dimension, such as length or height (e.g., in pixels), between a lower threshold percentage (e.g., 0.5%) and an upper threshold percentage (e.g., 10%), then the image data associated with the bounding box is maintained for image transformation. A portion of a surface that, for instance, has dimensions beyond range of threshold percentages likely includes non-character imagery or graphics. Character detector 444 is not limited to detecting characters as described above.

Grouped character generator 445 is configured to whether an identified symbol or likely symbol is associated with another identified symbol or likely symbol. As such, grouped character generator 445 can determine that the letter “N” in image 402 is likely associated with the letter “u,” in the sub-image including the word “Nutrition.” Further, grouped character generator 445 is configured to group characters to form words, such as word 404, and numbers, such as numeric amount 406. According to some embodiments, grouped character generator 445 is configured to detect a first symbol and a second symbol, and identify that the first symbol and the second symbol include image data for a first character and a second character, respectively. Grouped character generator 445 can also group at least the first character and the second character as a function of one or more chaining parameters to form a sub-image. An example of a chaining parameter is a size ratio or difference (or aspect ratio or difference). If the size ratio or difference (or aspect ratio) of the second symbol (or its bounding box) is within an acceptable range (e.g., within 3 times the size) relative to the first symbol, then the first and second symbols may be connected or joined as a portion of a word. This continues until usually a word or phrase can be identified. Another example of a chaining parameter is stroke width difference or difference in the weight of the font. Mismatches in stroke widths typically indicate nonrelated characters. For example, if a first symbol is not significantly formatted in a “bold” font relative to the second symbol, then grouped character generator 445 can chain a the first symbol to the second symbol, as well as other symbols to form a word or phrase. Another chaining parameter is the size of the space between the first symbol and the second symbol relative to the sizes of the first and second symbols. A significant amount of white space between the first and second symbol tend to indicate that the two symbols are unrelated. In one example, a white space between the first and second symbol cannot exceed, for example, 50% of the average width of the first and the second symbols. Grouped character generator 445 is not limited to detecting characters as described above. For example, similarity in color between a first symbol and a second symbol can be used to connect or group such symbols.

Sub-image extractor 446 is configured to extract or otherwise crop out sub-images representing combined or connected characters. For example, sub-image extractor 446 can extract out word (“Calories”) 424 and amount (“200”) 426 from an image 422. Likewise, sub-image extractor 446 can extract out phrase (“Dietary Fiber 2 g (8% DV). Sugars”) 434 from an image 432. Word 424, amount 426, and phrase 434 can be applied as data 470 to an adapted sub-image generator.

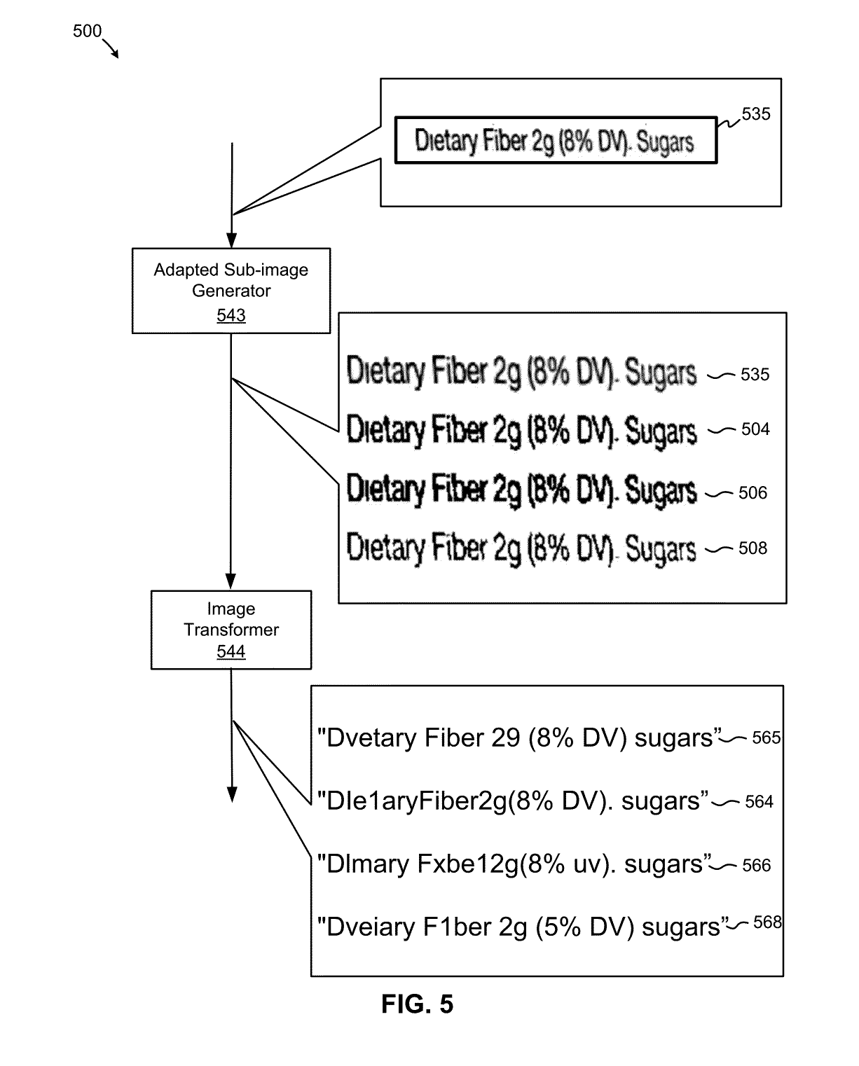

FIG. 5 is a diagram including an adapted sub-image generator, according to some embodiments. Diagram 500 includes an adapted sub-generator 543 coupled to an image transformer 544. Adapted sub-image generator is configured to determine a first value (includes a range of values) of a characteristic of image data associated with a group of characters in a sub-image, and determine a second value (includes a range of values) of the characteristic of image data associated with non-character imagery, such as a background image, that substantially excludes the characters in the sub-image. Adapted sub-image generator 543 is configured to select a subset of threshold values, each of the threshold values defining a boundary between a character and a portion of the non-character imagery (e.g., the background). In some examples, the threshold values represent different values between the first and the second values (e.g., 25% of the difference between the first and second values, 50% of the difference between the first and second values, 70% of the difference between the first and second values, etc.). The threshold values can be any value and need not be evenly displaced from each other. Based on the threshold values, adapted sub-image generator 543 forms each of the one or more adapted sub-images based on a corresponding threshold value of the subset of threshold values.

To illustrate, consider that the first and the second characteristics of the image data relate to pixel data values. Further, consider that phrase 535 is input into adapted sub-image generator 543. Adapted sub-image generator 543 is configured to detect a first pixel value representative of the background, which is depicted as a white color (e.g., pixel value 255), and a second pixel value representative of the imaged characters, which is depicted as a black color (e.g., pixel value 0). One or more threshold values can be selected or determined to generate different adaptations of sub-image phrase 535, whereby the threshold value determines the boundary between a character and the background. For example consider that three threshold values include a first threshold value of 128 (e.g., 50% between 255 and 0), a second threshold value of 64, and a third threshold value of 192. Note that threshold values need not be limited to these values. As shown, adapted sub image generator 543 passes original sub-image phrase 535 to image transformer 544. Further, adapted sub-image generator 543 adapts the sub-image phrase 535 with the first threshold value to form adapted sub-image 504. Similarly, adapted sub-image generator 543 can generate adapted sub-image 506 and 508 using the second and the third threshold values, respectively. As shown, sub-images 535, 504, 506, and 508 are applied to image transformer 544 which is configured to transform the imaged data into character data. Image transformer 544 transforms sub-image 535 into character data 565, sub-image 504 into character data 564, sub-image 506 into character data 566, and sub-image 508 into character data 568. In some cases, adaptive sub-image generator 543 can receive information from image transformer 544 or other subsequent processes and/or structures or circuits to calibrate the number of threshold values that are to be used, which, in turn, modifies the number of adapted sub-images to adjust the amount of redundancy for purposes of enhancing accuracy and reliability.

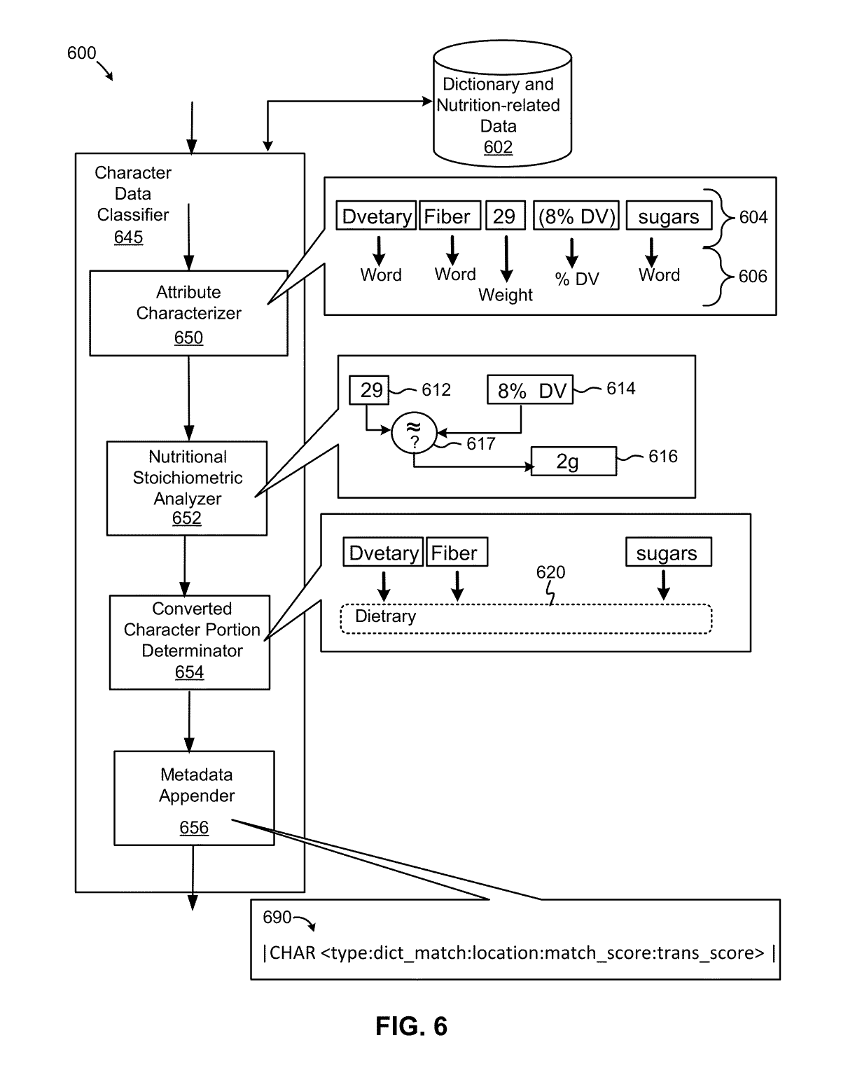

FIG. 6 is an example of a character data classifier, according to some embodiments. Diagram 600 shows a character data classifier 645 including an attribute characterizer 650, a nutritional stoichiometric analyzer 652, a converted character portion determinator 654, and the metadata appender 656. Attribute characterizer 650 is configured to classify subsets 604 of character data to form classified subsets of the character data. For example, attribute characterizer 650 can identify or otherwise tag a subset of character data with an indicator 606 that describes the contents as either a word (e.g., as matched with data in repository 602), a number, a weight, a percentage, a combination of characters, or any other symbol or value used in the context of nutrition. In some examples, a character data classifier 645 or any of its components can be configured to detect, identify, and/or correct variants in the character data. For example, character data classifier 645 can match the character data constituting “Dvetary” against data in database 602, and, upon detecting a likely match, can modify (i.e., convert) the character data from “Dvetary” to “Dietary.” In some embodiments, character data classifier 645 can segment character data into subsets of the character data that include recognizable entities based on a degree to which the subset of the character data matches data in a nutrition dictionary, or is a weight or percentage.

Nutritional stoichiometric analyzer 652 is configured to use determinable relationships between words, numbers or quantities, weights, daily values, and the like to determine whether a particular character data is within a range of acceptable values that are consistent other character data. For example, consider that character data 612 is identified as including a value of weight for dietary fiber, and character data 614 identified as including a percentage of a daily value for dietary fiber. A comparator 617 compares the value of character data 612 to the character data 614 and/or data for dietary fiber in repository 602 to determine that a weight of 29 is not likely accurate. Here, nutritional stoichiometric analyzer 652 determines character data 616 is to be converted to 2 g. In some cases, stoichiometric analyzer 652 applies a test to determine whether a last numeric character is a number “9,” which may indicate an errant transformation of the letter “g.” In this case, nutritional stoichiometric analyzer 652 identifies the number “9,” and in view of the values of other related character data, converts the number “9” to a letter “g.”

Converted character portion determinator 654 is configured to convert character data into converted character data 620. As described above, the word Dvetary” is tested against data in database 602, and, upon detecting a match, converted character portion determinator 654 can modify (i.e., convert) the character data from “Dvetary” to “Dietary.” Optionally, a metadata appender 656 can be included to append or associated (e.g., link to) metadata 690 to character data and/or converted character data to specify whether a subset of character data (“CHAR”) is of a certain “type,” such as a word, number, weight, or DV. If the subset of character data has a dictionary match (“dict_match”), then the correct spelling is included as “dict_match.” “Location” specifies a start position and an end position in a linear arrangement that the character data, and “match_score” indicates a relative degree of closeness to a matched dictionary word (e.g., in terms of a number of characters that need to be replaced, added or deleted to removed differences in characters. “ocr_score,” which is optional, can indicate a level of confidence that an image transformer correctly transformed a word or groups of characters (e.g., a surface with heavy shadows or extreme orientation differences may decrease the level of confidence). More or fewer information can be included in metadata 690, which may be provided to other components in an information extractor. Further, note that any of the components of character data classroom 645 can be disposed anywhere in the above pipeline, whether in series or parallel to each other.

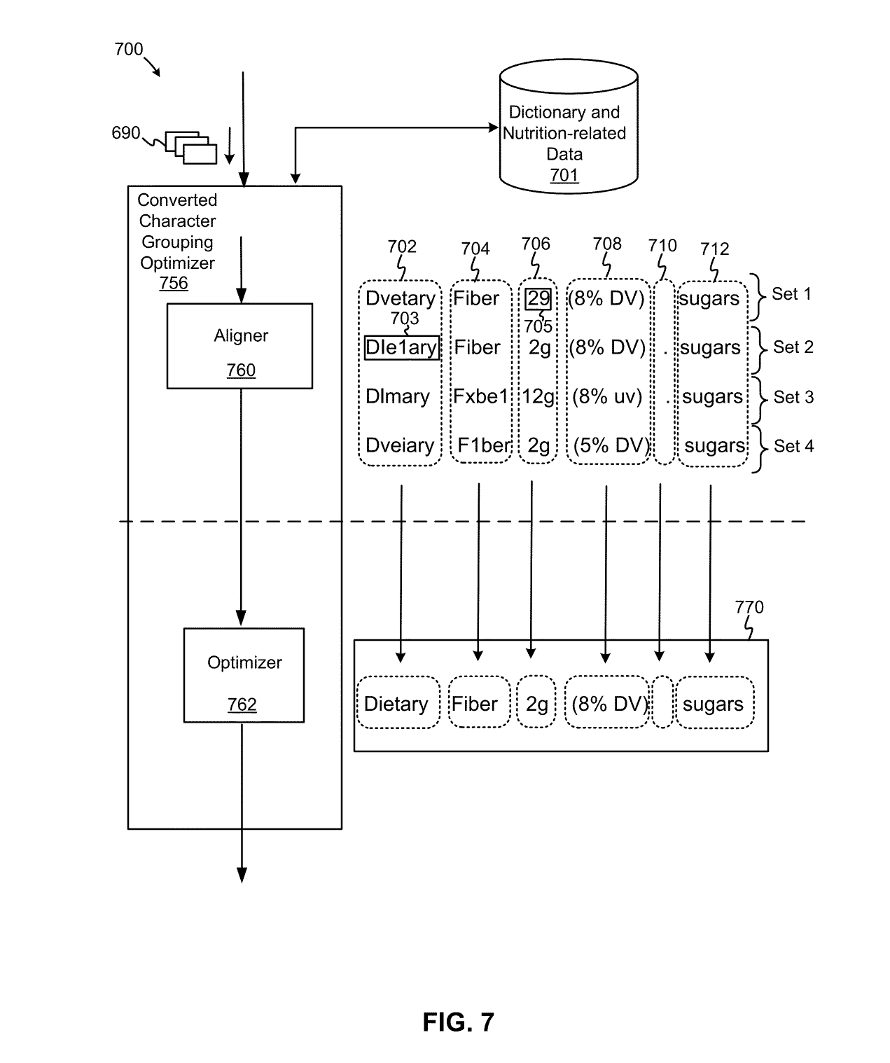

FIG. 7 is a diagram including an example of a converted character grouping optimizer, according to some embodiments. Diagram 700 depicts a converted character grouping optimizer 756 including an aligner 760 and an optimizer 762. Aligner 760 is configured to align classified subsets of the character data associated with a common attribute. For example, subsets 702 of character data associated with an attribute of “a first word” are aligned in a first collection of classified subsets, subsets 704 of character data associated with an attribute of “a second word” are aligned in a second collection of classified subsets, subsets 706 of character data associated with an attribute of “a first weight” are aligned in a third collection of classified subsets, subsets 708 of character data associated with an attribute of “a first DV” are aligned in a fourth collection of classified subsets, subsets 710 of character data associated with an attribute of “a first punctuation mark” are aligned in a fifth collection of classified subsets, and subsets 712 of character data associated with an attribute of “a third word” are aligned in a sixth collection of classified subsets. Note that in some examples, errant characters in subsets 702, 704, and the other subsets can be converted or otherwise corrected prior to alignment or after alignment. In some examples, aligner 760 provides level confidence that the contents in subsets 702-712 include relevant character information. For example, subsets 710 may or may not include relevant character data and may be excluded.

Optimizer 762 is configured to analyze the collections of classified subsets of the character data to determine the optimal subsets of character data that is to form a result as a converted character grouping 770 (or a converted group of characters). In some examples, optimizer 762 can be configured to use data, such as metadata 690 from a proceeding circuit or process, or from database 701, to determine which subset of character data in a collection is optimal for use in formed converted group of characters. For example, consider that subset 703 of character data is associated with metadata indicating that its matching score (e.g., degree of matching with a dictionary word) and confidence level (e.g., as determined by an OCR engine) is the best over the other subsets of similar character data. Therefore, optimizer 762 can select a subset 703 as a portion of converted group of characters 770. Further, optimizer 762 is configured to determine a best-fit or optimal subset in the other collections 704-712 from any of set 1 of character data through set 4 of character data.

In some examples, optimizer 762 is configured to identify a subset 703 of the character data associated with an attribute (e.g., a word), and to determine whether subset 703 of the character data corresponds to a range of values that are based on a function of a second attribute, a matched or potential dictionary word. An example of a range of values can be described by acceptable distances between character data in subset 703 and a matched dictionary word as a function of a quantity of added, deleted, or substituted characters to convert the character data in subset 703 into the dictionary word. Acceptable distances can define a degree of confidence that a word in subset 703 is the same in the dictionary in memory or database 701. Should optimizer 762 determine that subset 703 of the character data does correspond to the range of values, optimizer 762 can substitute one or more characters to correct subset 703 of the character data to be used as “Dietary” in converted group of characters 770. As another example, optimizer 762 is configured to identify a subset 705 of the character data associated with an attribute (e.g., a weight), and to determine whether subset 705 of the character data corresponds to a range of values that are based on a function of a second attribute, such as 8% DV for dietary fiber. Should optimizer 762 determine that subset 705 of the character data does not correspond to the range of values, optimizer 762 can substitute one or more characters to correct subset 705 of the character data to be used as “2 g” in converted group of characters 770.

According to some examples, optimizer 762 is configured to perform a union operation over the collection of classified subsets of character data to select the optimal subsets from each collection 702-712 for use and disposition into converted group of characters 770. Note that optimizer 762 and aligner 760 are not intended to be limited to the exemplary implementations described above, but rather can cooperate to form converted group of characters 770 in a variety of ways.

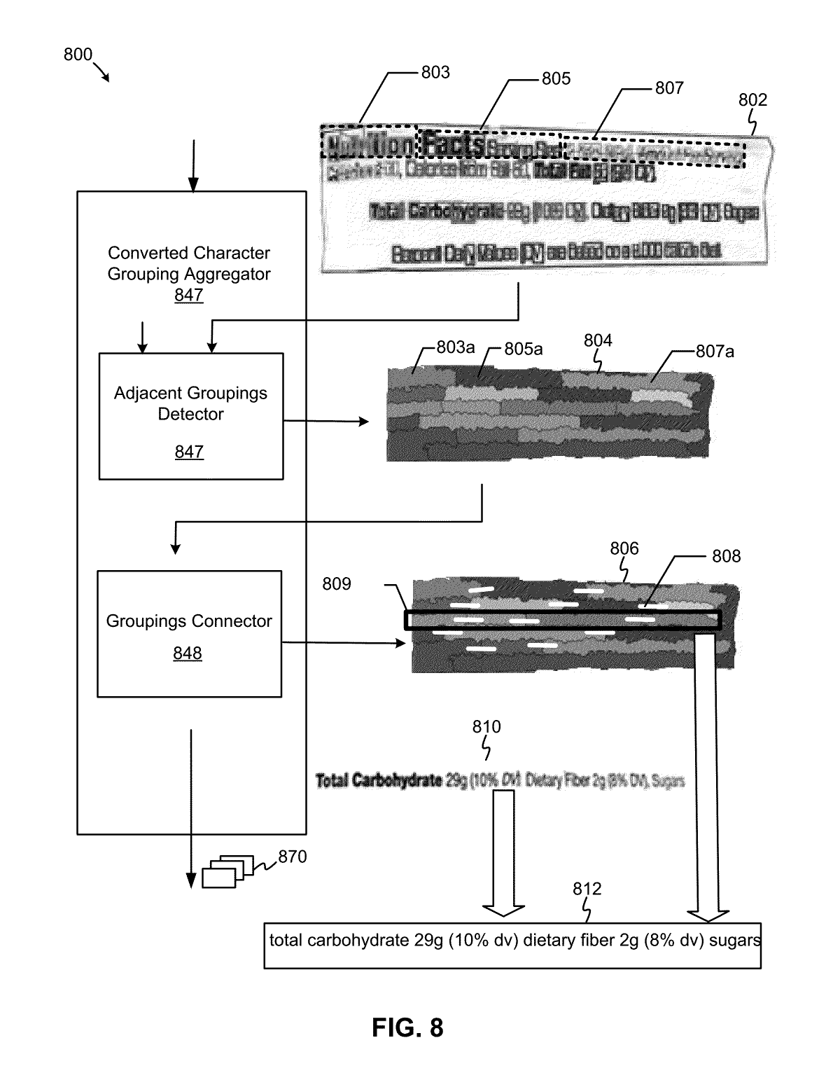

FIG. 8 is a diagram of an example of a converted character grouping aggregator, according to some embodiments. Converted character grouping aggregator 847 is configured to stitch or couple converted group of characters to merge character data together to form, for example, a larger grouping of character data (e.g., in a longer linear or columnar arrangement). In particular, converted character grouping aggregator 847 can stitch or couple converted group of characters together to establish a portion of symbols that are associated with a group of characters in the image (i.e., prior to transformation into character data).

Diagram 800 depicts converted character grouping aggregator 847 including an adjacent groupings detector 847 and a groupings connector 848. Adjacent groupings detector 847 receives data that depicts, for example, spatial relationships among sub-images of image 802, in which the sub-images include a group of image-based characters. For example, sub-images 803, 805, and 807 are shown to each include respective imaged-based characters. Adjacent groupings detector 847 is further configured to determine relative boundaries of the spatial regions in which image-based characters in sub-images 803-807, as well as other adjacent sub-images. As shown, adjacent groupings detector 847 generates data representing spatial regions associated with converted groups of characters 770 derived from some undue sub-images from image 802. The data representing spatial regions in diagram 800 is shown graphically to convey the functionality adjacent groupings detector 847 and need not be limited to graphical representations as shown, but rather can be maintained and any data structure relating spatial regions among each other. As an example, adjacent groupings detector 847 can be configured to define spatial regions 803a, 805a, and 807a, which correspond respectively to sub-images 803, 805, and 807. In at least one embodiment, adjacent groupings detector 847 is configured to create a watershed basin of influence associated with respective spatial regions 803a, 805a, and 807a to indicate the location at which two converted groups of character data are adjacent or contiguous. Thus, adjacent groupings detector 847 can implement watershed image processing techniques to define the spatial regions. Note that converted character groupings aggregator 847 is not intended to be limited to the implementation of watershed techniques.

Groupings connector 848 is configured to identify two or more converted groups of character data that are candidates for coupling, or otherwise emerging into a larger line or arrangement of text. As shown graphically, groupings connector 842 can determine data representing a link 808 between two spatial regions in which the converted groups of character data can be merged together. Box 809 were represents multiple spatial regions linked to form a line of text that spans nearly the width of the original image. From box 809, converted groupings of character data are coupled or stitched together to form a line 812 of character data including characters of “total carbohydrate 29 g (10% dv) dietary fiber 2 g (8% dv) sugars” from a portion of the original image 802. Line 812 of character optionally can be passed as data 870 to a parser that is configured to organize the character data and/or converted character data.

FIG. 9 is a diagram depicting a parser, according to some embodiments. Diagram 900 includes a parser 947 configured to receive data 870 representing string of characters (e.g., a string of text, numbers, symbols, and the like). Parser 947 is configured to parse the arrangement of characters associated with data 870 to identify information for a nutrient, and to associate the information for the nutrient to the converted characters that identify relevant information about the nutrient. For example, parser 947 can parse a substring of “total carbohydrate 29 g (10% dv) dietary fiber 2 g (8% dv)” to form a first data arrangement 972 including information regarding “total carbohydrates,” and to form a second data arrangement 974 including information regarding “dietary fiber.” According to some embodiments, the data arrangements 972 and 974 facilitate database storage, and also transmission to, or use by, an application that consumes nutrition-related information.

FIG. 10 is a diagram depicting an image enhancer, according to some embodiments. Diagram 1000 depicts an image enhancer 1049 including an image modifier 1060 and an image characteristic adjuster 1062 for generating data 1070 prior to communication to a sub-image detector. Image modifier 1060 is configured to modifying the image of the object to either flatten the illumination of the image or to rotate the image, or both. Image modifier 1060 can flatten the illumination so that regions that include symbols, such as text, have a more uniform background contrast. Further, image modifier will 1060 can also sharpen the image so that the text has sharper edges. In some cases, image modifier 1060 can be configured to rotate the image so that the text is optimally horizontal (e.g., left-to-right), or can rotate the image in any manner. image characteristic adjuster 1062 is configured to enhance the quality of the image by modifying the brightness or the contrast of the image, performing a greyscale operation to reduce non-character portions of the image (e.g., colored graphics). In some cases, image characteristic adjuster 1062 can also detect whether the text-to-background contrast is dark-on-light or light-on-dark, and can modify operation of an information extractor accordingly as well as converting a light-on-dark to dark text-on-light background. In at least one embodiment image enhancer 1049 can be configured to determine if the quality of an image is sufficient for information extraction, and can reject an image if portions are blurry, too dark, too bright, etc.

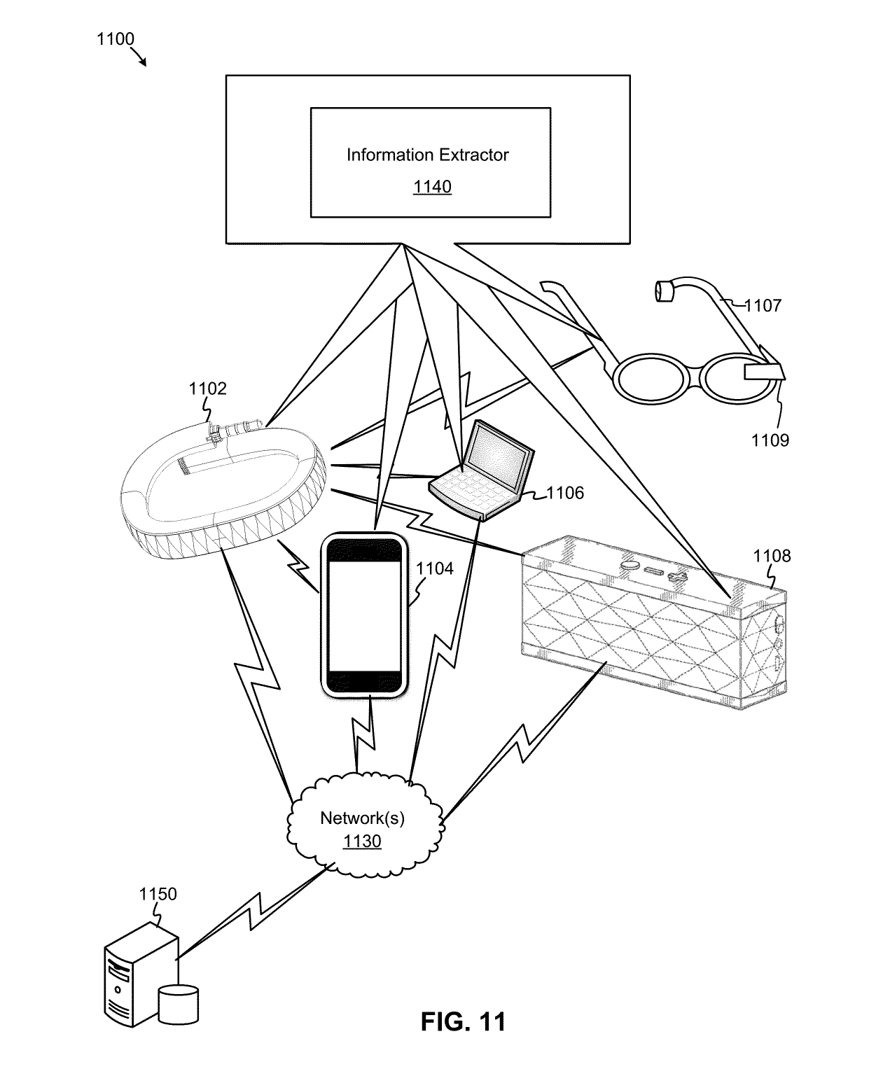

FIG. 11 is a diagram depicting various computing devices in which an information extractor (or a portion thereof) can be disposed, according to various embodiments. As shown, an information extractor 1140 and/or any of its one or more components, such as a sub-image detector, an adapted sub-image generator, an image transformer, a character data classifier, a converted character grouping optimizer, and a converted character grouping aggregator can be implemented in one or more computing such as an audio system 1108 (e.g., a Jambox® or a variant thereof), a mobile computing device, such as a laptop or tablet 1106, a wearable device 1102 or mobile phone 1104 (whether worn or carried), that include one or more processors configured to execute one or more algorithms in memory, whether disposed in one or more devices shown in diagram 1100. Further, information extractor 1140 can be disposed in eyewear 1107 (including a processor and memory) that includes an image capture device 1109. Also, information extractor 1140 can be disposed in server/database system 1150. Note that in some embodiments, devices 1102, 1104, 1106, 1107 and 1108 can be communicatively coupled to server/database system 1150 via network 1130. Images captured by any of these devices can be applied to an information extractor 1140 from which parsed character data can be transmitted to server/database system 1154 storage or can be transmitted among each other for use in nutrition-based applications. In one embodiment, eyewear 1107 can receive an image of nutrition information via image capture device 1109. Information extractor 1140 can be disposed in eyewear 1107 or in another device, such as device 1104, that is communicatively coupled to eyewear 1107. As such, either eyewear 1107 or device 1104 can transmit an alert to wearable device 1102 should an alert limit each trip upon extracting character data from captured image data. In view of the above, at least some of the elements information extractor 1140 can represent one or more algorithms. Or, at least one of the elements can represent a portion of logic including a portion of hardware configured to provide constituent structures/circuits and/or functionalities. These can be varied and are not limited to the examples or descriptions provided.

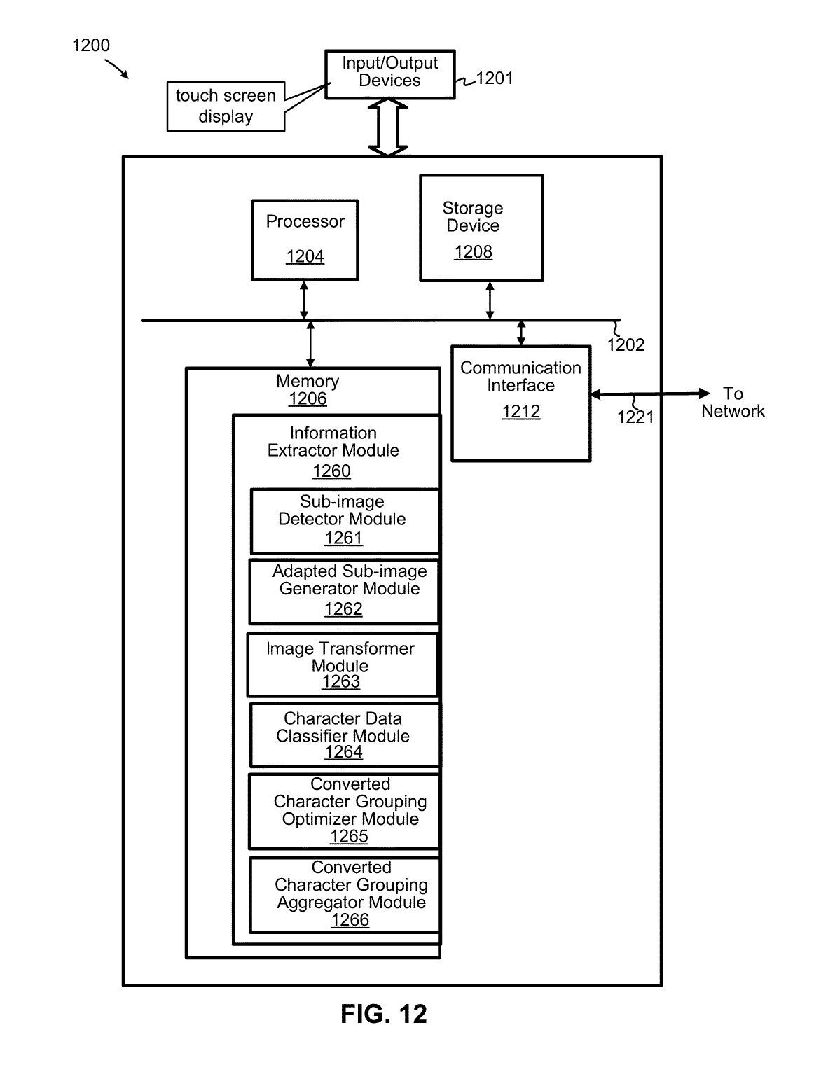

FIG. 12 illustrates an exemplary computing platform disposed in a media device, mobile device, or any computing device, for implementing the nutrition label information extractor, according to various embodiments. In some examples, computing platform 1200 may be used to implement computer programs, applications, methods, processes, algorithms, or other software to perform the above-described techniques. Computing platform 1200 includes a bus 1202 or other communication mechanism for communicating information, which interconnects subsystems and devices, such as processor 1204, system memory 1206 (e.g., RAM, etc.), storage device 1208 (e.g., ROM, etc.), a communication interface 1213 (e.g., an Ethernet or wireless controller, a Bluetooth controller, etc.) to facilitate communications via a port on communication link 1221 to communicate, for example, with a computing device, including mobile computing and/or communication devices with processors. Processor 1204 can be implemented with one or more central processing units (“CPUs”), such as those manufactured by Intel® Corporation, or one or more virtual processors, as well as any combination of CPUs and virtual processors. Computing platform 1200 exchanges data representing inputs and outputs via input-and-output devices 1201, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 1200 performs specific operations by processor 1204 executing one or more sequences of one or more instructions stored in system memory 1206, and computing platform 1200 can be implemented in a client-server arrangement, peer-to-peer arrangement, or as any mobile computing device, including smart phones and the like. Such instructions or data may be read into system memory 1206 from another computer readable medium, such as storage device 1208. In some examples, hard-wired circuitry may be used in place of or in combination with software instructions for implementation. Instructions may be embedded in software or firmware. The term “computer readable medium” refers to any tangible medium that participates in providing instructions to processor 1204 for execution. Such a medium may take many forms, including but not limited to, non-volatile media and volatile media. Non-volatile media includes, for example, optical or magnetic disks and the like. Volatile media includes dynamic memory, such as system memory 1206.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1202 for transmitting a computer data signal.

In some examples, execution of the sequences of instructions may be performed by computing platform 1200. According to some examples, computing platform 1200 can be coupled by communication link 1221 (e.g., a wired network, such as LAN, PSTN, or any wireless network) to any other processor to perform the sequence of instructions in coordination with (or asynchronous to) one another. Computing platform 1200 may transmit and receive messages, data, and instructions, including program code (e.g., application code) through communication link 1221 and communication interface 1213. Received program code may be executed by processor 1204 as it is received, and/or stored in memory 1206 or other non-volatile storage for later execution.

In the example shown, system memory 1206 can include various modules that include executable instructions to implement functionalities described herein. In the example shown, system memory 1206 (e.g., in a mobile computing device or at database, or both) can include an information extractor module 1260 and/or any of its one or more components, such as a sub-image detector 1261, an adapted sub-image generator 1262, an image transformer 1263, a character data classifier 1264, a converted character grouping optimizer 1265, and a converted character grouping aggregator 1266.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method comprising:
receiving an image of an object comprising:
symbols including characters;
identifying data representing a sub-image of a group of characters;
generating adaptations of the sub-image to form data representing an adapted sub-image;
transforming the sub-image of the group of characters and the adapted sub-image into character data;
classifying subsets of the character data for the sub-image and the adapted sub-image to form classified subsets of the character data;
forming at a processor a converted group of characters based on at least the classified subsets of the character data; and
coupling a plurality of the converted group of characters to establish a portion of the symbols associated with the group of characters.

2. The method of claim 1, wherein the receiving the image of the object comprises:
receiving the image of an enclosure as the object, the enclosure including a nutrition label associated with contents of the enclosure,
wherein the characters of the symbols constitute convey nutrition-related information.

3. The method of claim 1, wherein generating the adaptations of the sub-image to form the data representing the adapted sub-image comprises:
receiving the sub-image of the group of characters;
modifying the sub-image as a function of a characteristic of image data representing the sub-image; and
forming each of one or more adapted sub-images based on a different value for the characteristic.

4. The method of claim 3, wherein modifying the sub-image as the function of the characteristic of image data comprises:
determining a first value of the characteristic of image data associated with the group of characters in the sub-image;
determining a second value of the characteristic of image data associated with a background image excluding the group of characters in the sub-image;
selecting a subset of threshold values, each threshold value defining a boundary between a character and a portion of the background image; and
forming each of the one or more adapted sub-images based on a corresponding threshold value of the subset of threshold values.

5. The method of claim 4, wherein the first and the second characteristics of image data comprise pixel data values.

6. The method of claim 1, wherein classifying the subsets of the character data comprises:
selecting a portion of the character data as transformed from the sub-image of the group of characters or the adapted sub-image;
characterizing the portion of the character data as having at least one attribute associated with data representing a word stored in memory, data representing a number, data representing a value of weight, and data representing a value as a percentage daily value (“DV”) to form a characterized portion of the characterized data.

7. The method of claim 1, wherein forming the converted group of characters comprises:
identifying a collection of the classified subsets of the character data associated with a common attribute;
analyzing the collection of the classified subsets of the character data; and
determining an optimal classified subset of the character data for the common attribute.

8. The method of claim 7, wherein identifying the collection of the classified subsets of the character data comprises aligning the classified subsets of the character data associated with the common attribute, and analyzing the collection of the classified subsets of the character data comprises performing a union operation over the collection of the classified subsets of the character data.

9. The method of claim 7, wherein analyzing the collection of the classified subsets of the character data further comprises:
identifying a first subset of the character data associated with a first attribute;
determining whether the first subset of the character data corresponds to a range of values that are based on a function of a second attribute;
determining the first subset of the character data does not correspond to the range of values; and
substituting one or more characters to correct the first subset of the character data.

10. The method of claim 1, wherein coupling the plurality of the converted group of characters comprises:
identifying a first converted group of characters;
determining adjacent converted groups of characters; and
connecting the first converted group of characters and one of the adjacent converted groups of characters to form an arrangement of characters.

11. The method of claim 10, further comprising:
confirming the first converted group of characters is connected to an adjacent converted groups of characters based on relational data indicating a likely relationship.

12. The method of claim 10, further comprising:
parsing the arrangement of characters to identify information for a nutrient; and
associate the information for the nutrient to converted characters that identify the nutrient.

13. The method of claim 1, wherein identifying the data representing the sub-image of the group of characters comprises:
detecting a first symbol and a second symbol;
identifying the first symbol and the second symbol as including image data for a first character and a second character, respectively;
determining boundaries for the first character and the second character;
grouping at least the first character and the second character as a function of one or more chaining parameters to form the sub-image; and
extracting the sub-image from the image.

14. The method of claim 13, wherein the one or more chaining parameters include one or more of an aspect ratio difference, a size difference, and a stroke width difference for a portion of a character.

15. The method of claim 1, further comprising:
modifying the image of the object to either flatten the illumination of the image or to rotate the image, or both.

16. The method of claim 1, further comprising:
enhancing the quality of the image comprising:
modifying the brightness or the contrast of the image, or
performing a greyscale operation to reduce non-character portions of the image.

17. The method of claim 1, wherein transforming the sub-image of the group of characters and the adapted sub-images comprise:
performing optical character recognition to convert image data into the character data.

19. A system comprising:
a computing device comprising:
a memory including dictionary word and characters related to nutrition, and executable instructions;
a processor configured to execute the executable instructions to implement an nutrition label information extractor configured to:
receive an image of an object comprising symbols including characters;
identify data representing a sub-image of a group of characters;
generate adaptations of the sub-image to form data representing an adapted sub-image; and
transform the sub-image of the group of characters and the adapted sub-image into character data.

20. The system of claim 19, wherein the nutrition label information extractor is further configured to:
transform the sub-image of the group of characters and the adapted sub-image into character data;
classify subsets of the character data for the sub-image and the adapted sub-image to form classified subsets of the character data;
form a converted group of characters based on at least the classified subsets of the character data;
couple a plurality of the converted group of characters to a linear arrangement of characters;
receive the sub-image of the group of characters;
modify the sub-image as a function of a characteristic of image data representing the sub-image; and
form each of one or more adapted sub-images based on a different value for the characteristic.
